(19) United States
(12) Patent Application Publication
(10) Pub. No.: US 2026/0189386 A1
(43) Pub. Date: Jul. 2, 2026

(54) ENCRYPTION METHOD UTILIZING INFINITE GRID FOR PRIME IDENTIFICATION

(71) Applicant: NeuroVigil, Inc., Moffett Field, CA (US)

(72) Inventor: Philip Low, Moffett Field, CA (US)

(73) Assignee: NeuroVigil, Inc., Moffett Fiield, CA (US)

(21) Appl. No.: 19/435,449

(22) Filed: Dec. 29, 2025

Related U.S. Application Data
(60) Provisional application No. 63/740,037, filed on Dec. 30, 2024.

(51) Int. Cl. H04L 9/30

(52) U.S. Cl. CPC H04L 9/3033

(57) ABSTRACT

The present disclosure relates to techniques for generating prime by utilizing a grid-based method for prime number generation. Accordingly, a geometric shape may be generated iteratively on a grid of a cartesian plane, concentric with any one of the square shapes of a plurality of square shapes of the grid. At each iteration, a size of the geometric shape may be increased by a predefined unit, while identifying and counting the number of square shapes of the plurality of square shapes fully enclosed inside the geometric shape. A count representing a sum of the number of square shapes enclosed inside the geometric shape may be evaluated as a potential prime number using machine-learning based pattern recognition and verification. The disclosed technique may facilitate in optimizing the speed to verify a candidate prime number, further facilitating in cryptographic applications such as encryption, hashing, and frequency hopping.

### CROSS-REFERENCE TO RELATED APPLICATIONS

This application claims the benefit of U.S. Provisional Patent Application No. 63/740,037 filed on Dec. 30, 2024. The entire disclosure of the aforementioned application is incorporated by reference herein in its entirety for all purposes.

### BACKGROUND

Prime numbers are used in modern cryptography systems to encrypt information at rest and in transit. In modern cryptographic systems, prime numbers may be used for generating public and private keys. One challenge in information security systems is to generate large prime numbers by using a robust prime number generation method. The public key cryptography systems use both keys to do encryption and decryption of information. In one example, a sender may use its private key to encrypt information while a receiver may use the public key of the sender to decrypt information.

In cryptography, secure prime number generation methods may include deterministic and probabilistic techniques such as Elliptic Curve Primality Proving (ECPP), Fermat's primality test, and Miller-Rabin test. These approaches may identify large prime numbers, which may be used in cryptographic systems. Despite these methods, generating large prime numbers remains a computationally intensive workload in cryptography systems, as the distribution of prime numbers and their frequency of occurrence is not deterministic. Additionally, the existing solutions may not increase the probability of discovering prime numbers within a computationally feasible time, specifically for large numbers, due to the inherent complexity of factoring large numbers into their prime factors.

### SUMMARY

Some embodiments of the present disclosure relate to techniques for generating prime numbers by utilizing a grid-based method. The disclosed technique may enhance the probability of discovering large prime numbers within a practical period. The generation of prime number may include generating a geometric shape on a grid of a cartesian plane comprising a plurality of grid squares, concentric with a center of a grid square. The grid square may refer to each of the smallest, regularly arranged square units that make up the grid. In the cartesian plane or grid system, each grid square may represent a discrete area with defined x and y coordinates. The grid may be of an infinite size, enabling generation of the geometric shape of any size. In some aspects, a grid of a defined size or boundary may be used. Each grid square of a plurality of grid square represents a discrete area with defined x and y coordinates within a grid layout. In some aspects, the underlying system may implement alternative geometric shapes, such as ellipses or polygons, to alter the patterns of identifying prime numbers. In another example embodiment, N-dimensional shapes may also be used to generate prime numbers. In this N-D configuration, a geometric shape (like a N-dimensional sphere) might be drawn around a sets of cubes of an infinite N-D grid. The same principles of identifying enclosed grid elements may be used, but in N dimensions.

The geometric shape may comprise a circle, a rectangle, an ellipse, or a square. The total number of grid squares (also referred herein as squares) fully enclosed inside the geometric shape may be identified to determine whether the sum adds up to be a prime number. This may be computed directly or done by leveraging one or more machine-learning models such as pattern recognition models, including neural networks to identify and count specific shapes in an image. The detection and classification of the geometric shape and the grid squares fully enclosed inside the geometric shape may be performed by employing object detection algorithms, followed by segmentation to isolate and categorize the grid squares fully enclosed inside the geometric shape. Once the shapes are identified, an object counting technique may be employed to count the number of targeted shapes present inside the generated shape. The count value may serve as the candidate for determining whether it is a prime number. To check for primality, the disclosed techniques may either use a deterministic primality test, which mathematically verifies the primality of a number, or a classification model that may be trained to recognize prime and non-prime numbers based on learned patterns. The combination of machine-learning models for image analysis and mathematical algorithms for primality testing may allow for an automated system capable of determining prime numbers from graphical inputs, by combining image processing or recognition with computational mathematics.

In some aspects, the prime number may be used to encrypt and decrypt information sent or received on a digital information channel by generating an encryption key associated with the prime number. In this context, prime numbers may form the basis of widely used cryptographic methods, such as the RSA algorithm, which is based on the difficulty of factoring large numbers into their prime factors. In a typical public key cryptosystem, a pair of keys may be generated including a public key and a private key. The process may begin by selecting two large prime numbers at random, generated by the disclosed techniques. These large primes may be multiplied together to form a composite number, which may serve as part of the public key. The private key can be derived from the large prime numbers and their properties, and it remains secretly stored on a communication endpoint and is not transmitted on the communication channel. When a sender wishes to encrypt a message or a digital information, the sender may use the public key of the receiver to encrypt the message. However, only the recipient, who has the corresponding private key, may be able to decrypt the message. The encryption process relies on the fact that it may be easy to multiply two large prime numbers together to create a composite number, but computationally very difficult or infeasible to factor the composite number back into its original prime factors. The asymmetry between encryption and decryption processes can make it difficult for an unauthorized party to decrypt the message without knowing the private key of the receiver, even if the public key of the receiver may be known to everyone.

In some other aspects, the prime number may be utilized in processes such as hashing and frequency hopping. For example, in certain hash functions, prime numbers may be used to help distribute the hash values uniformly across a range of possible outputs, thereby improving the efficiency and reliability of hash-based structures (e.g., hash tables). When prime numbers are used as a divisor or multiplier in the hashing process, the uniqueness of prime numbers may help in minimizing the occurrence of these collisions due to a likelihood of two inputs producing the same hash value, making the system more efficient.

Additionally, prime numbers may be leveraged for frequency hopping in communication systems particularly in secure wireless communications. In frequency hopping, a signal may rapidly switch between different frequencies to avoid interference, prevent jamming, and/or increase security. The choice of frequency channels may involve mathematical algorithms that leverage large prime numbers. For example, primes (interchangeably used with prime numbers) may be used to select the sequence of frequencies or to design hopping patterns that may be difficult to predict, making it harder for an eavesdropper to intercept or interfere with the communication on the digital channel. The use of primes may enable a random and unpredictable sequence of frequency changes, enhancing the security of the system.

In some embodiments, a system is provided that includes one or more data processors and a non-transitory computer-readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 shows an exemplary block diagram for encrypting digital information using an encryption module in accordance with some embodiments of the present disclosure.

FIG. 2 shows an example implementation of the encryption module to generate an encryption key when an encryption request is received.

FIG. 3A shows an example illustration of a first iteration of generating a geometric shape on an infinite grid to find prime numbers in accordance with some aspects of the present disclosure.

FIG. 3B shows an example illustration of a second iteration of generating the geometric shape on the infinite grid with an increased size to find the prime numbers.

FIG. 4 illustrates an example flowchart for identifying a set of prime numbers for generating a public key and a private key for an encryption system.

FIG. 5 shows an exemplary block diagram for generating a hash code by using the prime numbers in accordance with some aspects of the present disclosure.

FIG. 6 shows an example implementation of a frequency hopping module that uses the prime numbers to generate a hopping waveform.

FIG. 7 illustrates an example plot of estimated percentage distribution of prime numbers within an increasing sequential range of integers in comparison with a subset of prime numbers located inside the geometric shape.

FIG. 8 shows an example flowchart for searching of the prime numbers in a vicinity in accordance with some embodiments of the present disclosure.

FIG. 9 shows an example illustration of a computer system in which various aspects of the present disclosure may be implemented.

### DETAILED DESCRIPTION

Some embodiments of the present disclosure relate to finding and verifying one or more potential prime numbers by incorporating a graphical method involving one or more geometric shapes drawn on an infinite grid. By using the identified prime numbers, one or more encryption keys may be generated to be used in various cryptographic systems. The encryption keys may be used to encrypt and decrypt information sent on a digital information channel across a network. Once a request is received to encrypt digital information on a sender device, the encryption module may start the process of generating large prime numbers. Initially, a geometric shape (for example a circle) may be generated on a grid of a cartesian plane composed of individual grid squares (also referred herein as squares). The grid may be of an infinite size, expanding according to the computational power of the underlying system, enabling generation of the geometric shape of any size. The center of the geometric shape may be aligned to be concentric with the center of any one of the grid squares of the infinite grid. In some aspects, a grid of a defined size or boundary may be used. Each grid square of a plurality of grid square represents a discrete area with defined x and y coordinates within a grid layout.

Following the generation of the geometric shape, the encryption module may identify the total number of grid squares of the infinite grid fully enclosed within the boundaries of the geometric shape using one or more machine-learning models. The machine-learning model may include a pattern recognition model or a classification model, both of which may be configured to analyze and interpret the relationships between the geometric shape and the grid squares on the infinite grid. These models may be trained to identify patterns or classify certain characteristics of the grid based on the positioning and arrangement of the geometric shape. A pattern recognition model may detect recurring structures, shapes, or relationships within the infinite grid. By analyzing enclosing pattern of grid squares within the geometric shape on a grid, the model may detect patterns that correspond to certain numbers or properties, such as the number of enclosed grid squares. For example, the model may detect whether a certain portion of the grid forms a recognizable pattern that corresponds to a prime number based on the arrangement of a geometric shape. A classification model, on the other hand, may be used to classify the enclosed grid squares into predefined categories based on their characteristics. The model may be trained to distinguish between grid squares that may be fully enclosed by the geometric shape and those that are not, classifying them as “inside” or “outside” the shape. It may also classify whether the number of enclosed grid squares is odd or even, or if the configuration may conform to property of a prime number.

In both cases, these machine-learning models may be configured to take input from the grid and the placement of geometric shape and generate a result by matching the input to patterns learned during the training phase.

The number of grid squares can then be summed, with the sum conditioned to yield an odd number. The concentric arrangement can affect whether the summed number of grid squares enclosed is odd or even. For instance, when a geometric shape like a circle is centered on one of the grid squares, it may create a symmetry that influences how the grid squares are fully enclosed within the circle. The center of the circle being aligned with the center of a grid square (rather than at an intersection of the grid lines) results in a unique distribution of enclosed grid squares. By centering on a square, the boundary of the circle may tend to intersect a different set of grid squares compared to when it is centered on grid lines. When the circle is centered on a square grid, the grid squares that are fully enclosed will result in an odd number. This happens because the distribution is such that there may be an unpaired square due to symmetrical considerations. In contrast, if the circle were to be centered on a point between grid squares (such as at the intersection of grid lines or the lines of intersection of the by plane), the distribution might be evenly balanced, often making the sum even. Since the circle expands outward uniformly in all directions, centering on a square aligns the enclosed area in a way that generates an odd count value. This effect is maintained as the circle is increased in its radius, consistently influencing how many grid squares are enclosed.

The primality of the sum may be evaluated using one or more machine-learning (ML) algorithms specifically trained for prime number identification. These algorithms may be designed based on techniques like neural networks or decision trees, trained on datasets of large numbers to distinguish primes from non-primes. The training data may include labeled examples where each data point has been verified as prime or non-prime, ensuring that the models are optimized for accurate prediction.

Various formulas and ML-based techniques may be utilized to identify whether a grid square from the plurality of grid squares lies entirely within the geometric shape. The geometric properties may be leveraged by using models capable of recognizing and classifying enclosed elements. Algorithms such as spatial classification models or regression-based systems could provide a method for accurate square identification. Advanced geometric deep learning approaches may also be considered, especially when scaling this method to larger or more complex geometric shapes.

In some aspects, the verification of the potential prime number may be done by leveraging a primality test that may comprise of a deterministic algorithm or a probabilistic algorithm. The primality test can be run on the set of potential prime numbers. A heuristic test, a Fermat primality test or a Millier-Rabin primality test can be used to check the validity of an element of the set of potential prime numbers. In some disclosures, the probabilistic algorithm may be used, as it may provide a simple test to verify the potential prime number.

If the sum is verified to be a prime number or otherwise, nevertheless the process may continue iteratively to generate larger prime numbers by increasing the size of the geometric shape (in case of a circle, it may be done by increasing the length of its radius). The radius (or equivalent size parameters) may increase the size of the geometric shape by a specified number of units, such as 0.5 or 1 in both x and y dimensions. This iterative procedure may be repeated until the required number of prime number elements of the set of prime numbers is generated. The set of primes may then be used for generating a public key and a private key, which may be used to encrypt the digital information using public key cryptography. In some example embodiments, only one prime number may be generated that may be used to create one or more encryption keys.

In some other aspects, the prime numbers may be utilized in processes like hashing and frequency hopping as well. Such processes may contribute to adding layers of complexity and security in various applications. In case of hashing, prime numbers may generate efficient and collision-resistant hash functions. By using the generated set of prime numbers, a hashing system may generate unique keys with a smaller number of collisions. The reduction is possible because prime numbers distribute hash values more uniformly in a range, minimizing the likelihood of two different and distinct inputs map to the same output. When prime numbers are generated using a geometric approach, potentially dense distribution of primes occurs that provides an added level of unpredictability, making it difficult for adversaries to guess the behavior of the hash function.

Using prime numbers in hashing may enhance data integrity and security. In a typical hashing scenario, when files are hashed using prime-based keys, even minor changes in the input may drastically change the output, preventing tampering with the data. The disclosed infinite grid method may generate primes that may have a natural variability. Once such prime numbers are used in hash functions, increasing their cryptographic strength significantly.

In frequency hopping, prime numbers may play an important role in defining the hopping sequence. Frequency hopping relies on rapidly changing transmission frequencies in a pseudorandom manner, and primes can be used to ensure that these sequences are not only non-repetitive but also difficult to predict. Consequently, the system can continuously adapt to threats, by optimizing hopping spread across frequencies in a non-linear, complex manner, ensuring security against passive and active attacks. By employing a prime-based sequence derived from the disclosed technique, digital information channels may become difficult to wiretap by eavesdroppers, as with each encryption request the frequency hopping patterns can be dynamically adjusted in real-time. Moreover, primes generated from geometry or representational constructs may display unique distribution patterns, optimizing the frequency hopping spread, ensuring minimal overlap and maximum spectral efficiency.

In some aspects, the encryption module may implement alternative geometric shapes, such as ellipses or polygons, to alter the patterns of identifying prime numbers. In another example embodiment, three-dimensional shapes may also be used to generate prime numbers. In this 3-D configuration, a geometric shape (like a sphere) might be drawn around a set of cubes of an infinite 3-D grid. The same principles of identifying enclosed grid elements are used, but now in three dimensions, enhancing the security of cryptographic systems.

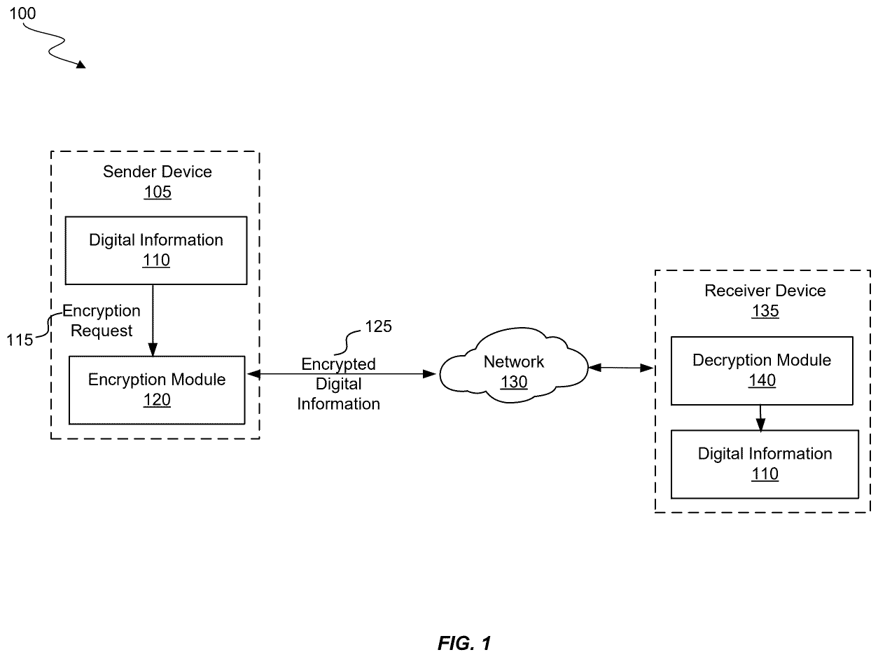

FIG. 1 shows an exemplary block diagram 100 for encrypting digital information 110 using encryption module 120 in accordance with some embodiments of the present disclosure. The encryption module 120 may be configured to generate one or more encryption keys for encrypting the digital information 110. The digital information 120 may be some stored information residing on a sender device 105 or an information to be communicated from the the sender device 105 to a receiver device 135. The sender device 105 may utilize the encryption module 120 when an encryption request 115 is received by any application running on the sender device 105. Upon receiving the encryption request 115, the encryption module 120 may start the generation of one or more encryption keys that may be used to encrypt the digital information 110.

The encryption module 120 of the sender device 105 may use a private key of the sender device 105 to encrypt the digital information 112 before sending it on the digital communication channel 125 in a network 130. In some embodiments, the network 130 may include one or more communication protocols including, for example, TCP/IP, POP, SMTP, HTTP, and/or the like. On the other end of the communication endpoint, a decryption module 135 of the receiving device 135 may use a public key of the sender device 105 to decrypt the encrypted digital information 112. This example embodiment may be referred to as “asymmetric encryption” or “public key encryption” system. One real world application of this method is Rivest-Shamir-Adleman (RSA) algorithm.

In another example embodiment, the sender device 105 and the receiver device 135 exchange a private (secret) key using out-of-band communication using a reliable and secure mechanism. Once the key is exchanged, then the private key is used by the encryption module 120 of the sender device 105 to encrypt the digital information 110 and the same private key is used by the decryption module 140 of the receiving device 135 to decrypt the received encrypted digital information 125. This example embodiment may be referred to as “symmetric encryption” and AES algorithm is a real-world application of this.

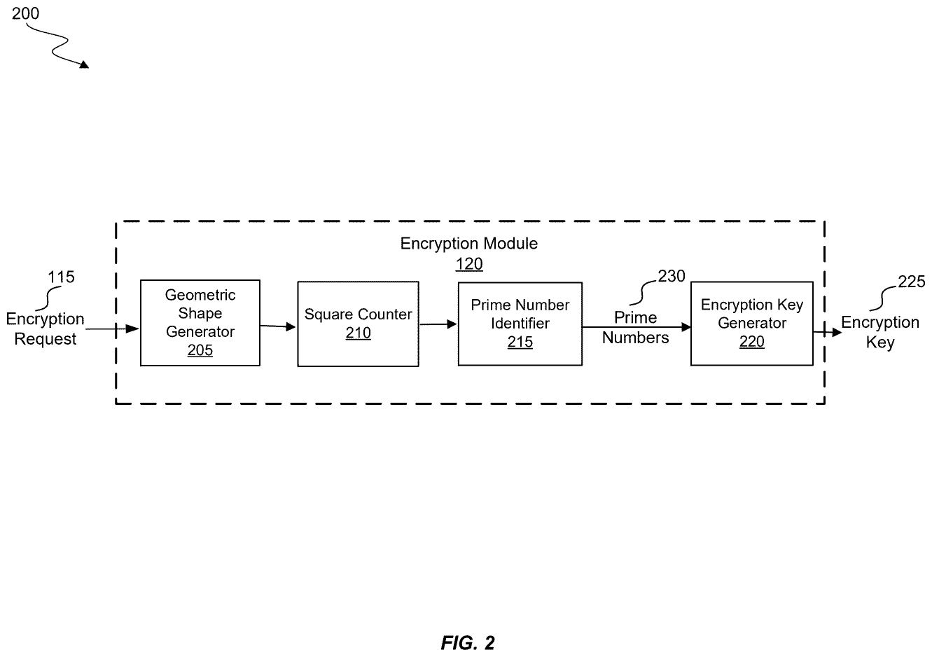

FIG. 2 shows an example implementation of an encryption module 120 to generate an encryption key 225, when an encryption request 115 is received by an encryption module 120 of a sender device 105. Once the encryption request 115 is received, the encryption module 120 starts its operation. The encryption module 120 may include various components that systematically generate prime numbers 230 to generate the encryption key 225. The process may begin with a geometric shape generator 205, which may generate a geometric shape (for example a circle, ellipse, square, etc.,). The center of the geometric shape may be placed such that it is concentric with any one of the grid squares of the plurality of an infinite grid. Following the generating of the geometric shape on the infinite grid, a square counter 210 may be utilized to evaluate the number of unit grid squares on the grid that are fully enclosed within the geometric shape 205. For example, if the geometric shape 205 is a circle, for each square of the infinite grid located at (x_i, y_i) the following check may be performed using the condition:

$${( x - {x}_{0} )}^{2} + {( y - {y}_{0} )}^{2} \leq {r}^{2} , \qquad ( Eq . 1 )$$

where (x₀,y₀) represents the center of the circle and r is its radius. The Eq. 1 determines a set of (x,y) coordinates, which are in the contained area of the circle in the cartesian plane, such that all grid squares inside this area need to be counted. (x_i, y_i) represents a fixed position of each square's center within the infinite grid. When evaluating whether a square is fully enclosed within the circle, the coordinates (x_i, y_i) are checked against the boundary condition of the circle using Eq.1. If the four corners of the square satisfy Eq.1, the square is to be counted and a square counter 210, the variable maintaining the count of grid squares, is incremented by 1. In some examples, a formula to determine the number of N-dimensional cubes fully contained in the N-dimensional sphere may be used, or machine-learning algorithms may be used to count the grid squares within the bounded circle and the square counter 210 may be incremented by the count of grid squares in one step, speeding up the process significantly. For example, a convolutional neural network (CNN) may be trained to classify grid squares that are fully enclosed within a geometric shape using labeled image data. Alternatively, graph-based algorithms may be used to model the infinite grid and they utilize efficient node traversal methods to count the grid squares in the area enclosed by the geometric shape.

Once the total count of fully contained grid squares is computed, the count may be checked to see if it is a prime number using a prime number identifier 215. The prime number identifier 215 may utilize a combination of deterministic and probabilistic tests, such as the Miller-Rabin test or Lucas-Lehmer test particularly suited for Mersenne primes. Machine-learning models may also be employed to predict the primality of large numbers based on features derived from the distribution of digits or modular patterns. If the number can be verified as a prime number, it may be added to a set of prime numbers.

The output of the prime number identifier 215 may be fed to an encryption key generator 220 that may utilize the set of verified primes to create the public key and the private key. The public key and the private key may be used for encrypting the digital information 110 securely. Using the identified primes, an asymmetric encryption algorithm like RSA could generate keys. For key generation, large primes p and q from the set of prime numbers 230 may be multiplied to produce a composite number N such N=p×q, where the modulus N forms part of the public key and the private key.

In some other aspects, the encryption module 120 may be extended to a 3-dimensional cartesian coordinate system. Here, the geometric shape may be a sphere instead of a circle. The sphere's radius may be increased iteratively, and the unit cubes would be counted instead of the squares. The mathematical condition for full enclosure may adapt to:

$${( x - {x}_{0} )}^{2} + {( y - {y}_{0} )}^{2} + ( z - {z}_{0} ) \leq {r}^{2} , \qquad ( Eq . 2 )$$

where z and z₀ may represent coordinates in the third dimension. Machine-learning models and optimization algorithms can be similarly trained and utilized to efficiently detect the enclosed cubes in a geometric shape and count them.

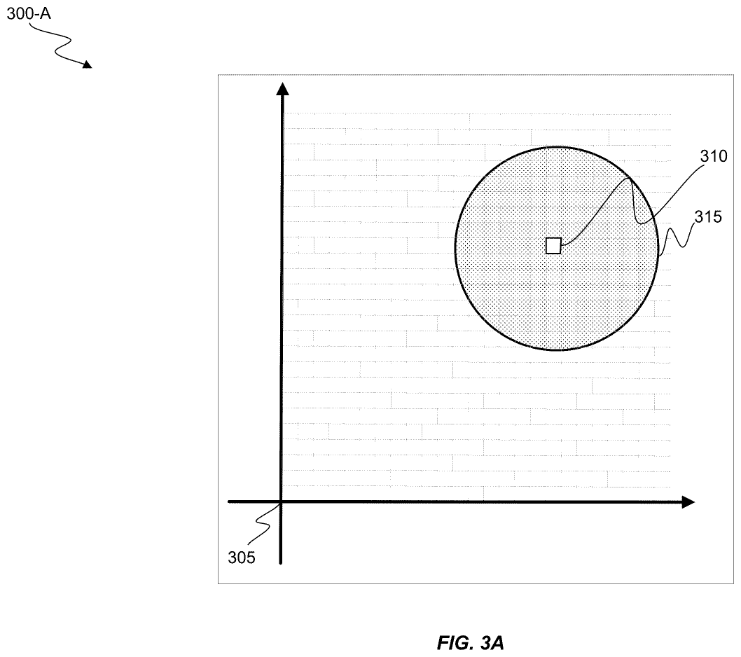

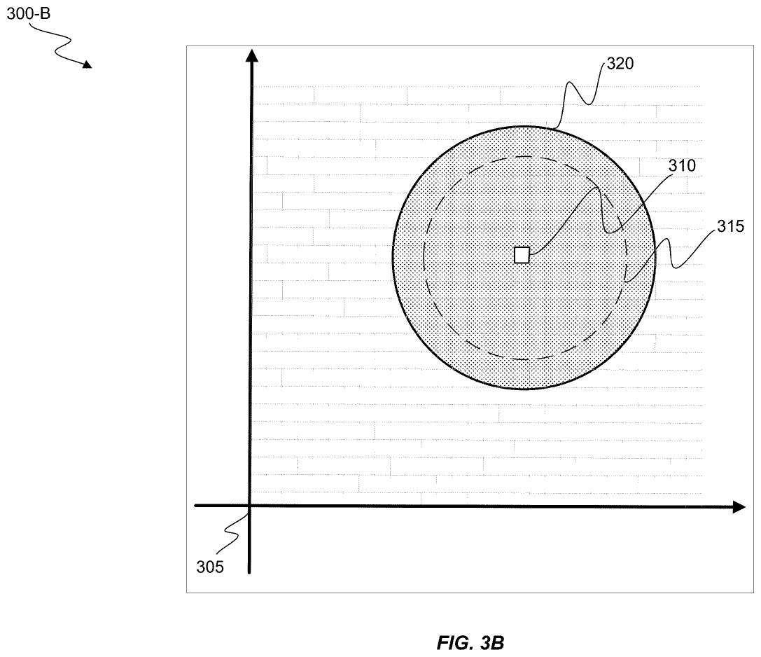

FIG. 3A shows an example illustration of a first iteration of generating geometric shape 315 on an infinite grid 305 to find the set of prime numbers 230 in accordance with some embodiments of the present disclosure. The encryption module 120 may initiate the geometric shape generator 205, responsible for generating the geometric shape 315 on the infinite grid 305. The infinite grid 305 may consist of an array of grid squares arranged in an infinite, two-dimensional pattern. The geometric shape 315 may be placed anywhere on the infinite grid 305 depending on a specific application and algorithm.

In the first iteration, the center of the geometric shape 315 may be generated concentrically with the center of square 310 within the infinite grid 305. The square 310 may be one of many grid squares in the infinite grid 305, that may act as a spatial reference for the position of the geometric shape. By aligning the geometric shape 315 with the center of square 310, the system may accurately place the geometric shape 315 on the infinite grid 305, creating a correct starting point for the subsequent iterations.

As the iterations progress, the encryption module 120 may refine and update the position or size of the geometric shape 315, improving the accuracy of prime number identification within the infinite grid 305. In some aspects, the grid used in the encryption module 120 may be of a predefined length or size. In some other aspects, the grid may either be 2 dimensional or 3 dimensional.

FIG. 3B shows an example illustration of a second iteration of generating a bigger geometric shape 320 (in this case the radius of the circle is increased) on the infinite grid 305. The bigger geometric shape 230 may enhance range in which the elements of the set of prime numbers 230 can be searched and identified. In the second iteration, the encryption module 120 may increase the radius of the geometric shape 315 (i.e., a circle) in FIG. 3A by approximately one unit to get the bigger geometric shape 320. The geometric shape generator 205 then plots this bigger geometric shape 320 with its center still concentric with the square 310. This updated configuration may enable reevaluation of the grid squares of the plurality of grid squares fully contained within the bigger geometric shape 320.

The boundary of the circle may exhibit interesting properties: as the radius increases, the number of grid squares contained with the circle can significantly change. For each new value for the radius, machine-learning algorithms may be trained to predict whether contained grid squares will yield a number that is a prime number. A CNN or other classification algorithm may be used to quickly identify patterns in the infinite grid 305, reducing the time needed to determine if a square is fully contained within the geometric shape 320. Algorithms like simulated annealing or evolutionary methods may optimize the method for increasing the radius of the circle, focusing on areas of the infinite grid with a higher likelihood of achieving numbers that are prime numbers. Machine-learning may help recognize prime-generating radii patterns based on a priori learnt patterns, improving the efficiency of searching for prime numbers as more patterns are learnt and stored.

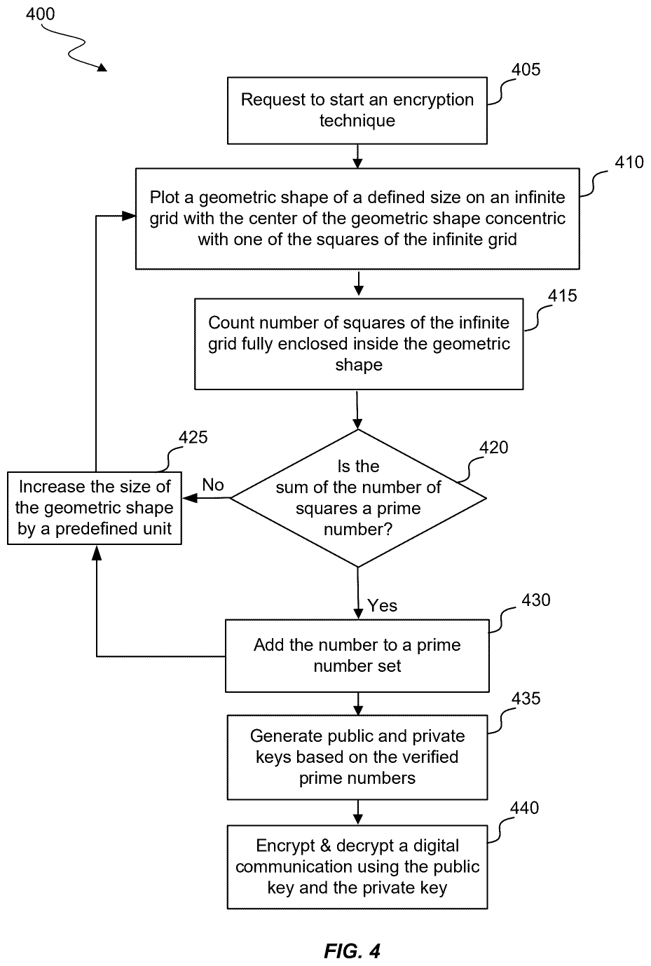

FIG. 4 illustrates an example flowchart for identifying the set of prime numbers for generating the public key and the private key for doing encryption. Initially, at block 405, a request to initiate the encryption technique may be received. Once activated, the encryption module 120 may proceed to block 410, by generating the geometric shape 315 with a defined size on the infinite grid 305 with the center of the circle placed concentrically with the center of a square 310 of the plurality of grid squares on the infinite grid 305, ensuring a well-defined geometric reference for subsequent computations.

At block 415, the number of grid squares on the infinite grid, which are fully enclosed within the boundaries of the geometric shape 315, may be identified and counted. At block 420, a prime number verification method verifies whether the number representing the count of the grid squares on the infinite grid is a prime number or not. If it is not a prime number, the number may be discarded and the process may proceed to the next iteration at block 425, in which the size of the geometric shape 315 may be increased in both the x dimension and y dimension (in case of a circle, by increasing its radius) by approximately 0.5 to 1 unit. This iterative process continues until a prime number is found. At block 420, if the count of the contained grid squares happens to be a prime number, the verified prime number may be added to the set of prime numbers. If the number of elements in the set of prime numbers is less than the desired value, the iterative method continues at block 425 until the set of primes contains the desired number of elements. The need for size of the set of prime numbers may vary significantly depending on the security level for the encryption key 225. The prime numbers in the set of prime numbers 230 may generate one or more public and private keys for doing encryption. At block 435, the encryption module 120 may use these prime numbers to generate the public and private keys for encryption, ensuring the robustness and security of digital information 112. Finally, at block 440, the generated keys may be used to encrypt and decrypt digital information 112.

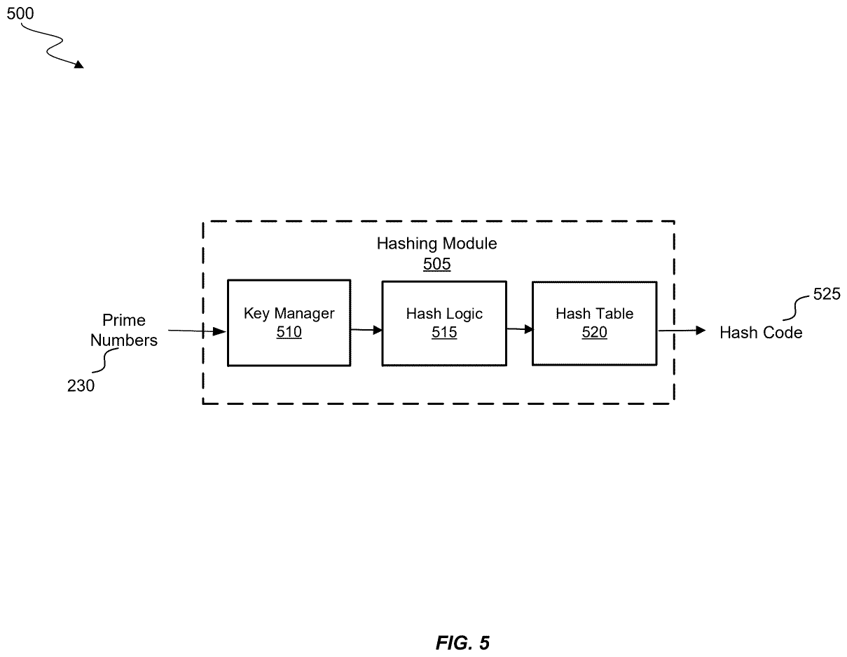

FIG. 5 illustrates an exemplary block diagram for generating a hash code 525 by using the set of prime numbers 230. The set of prime numbers 230 generated by an encryption module 120 using a geometric shape generator 205, a square counter 210 and a prime number identifier 215 may be utilized in the hashing process. One such example is illustrated in FIG. 5, where a hashing module 505 may generate unique hash codes by leveraging the set of prime numbers 230 as its input process. The hashing module 505 may include various components that can enable a secure hashing process. Hashing process may begin with a key manager 510, which can handle, organize and prepare the set of prime numbers 230 for the hashing process. The key manager 510 may forward a subset of the set of prime numbers 230 to the next block (e.g., a hash logic 515) in a correct sequence and format. The key manager 510 may also maintain a repository of the set of prime numbers 230 that were previously used to avoid redundant computations for generating the hash code 525. For instance, in cryptographic applications, the key manager 510 may keep track of specific prime numbers 230 that may be used for encryption, enabling secure and verified prime numbers 230 to be employed in the hashing process.

After sequencing and formatting, a hash function, also referred to as the hash logic 515 may use the set of prime numbers 230 to maximize randomness such that from the hash code 525 one could not determine the specific prime numbers that are used to generate the hash code 525. For this, the hash logic 515 may apply mathematical operators, often involving modular arithmetic or bitwise operations, to transform the set of prime numbers 230 into a unique hash output. The hash logic 515 may also create a unique signature for each input prime number that makes it difficult to predict the prime number by reverse-engineering the unique signature. The set of prime numbers 230, due to their inherent unpredictability and distribution properties, may provide a uniform distribution of hash values reducing the likelihood of collisions (e.g., different inputs producing the same output). The randomness and distribution of the elements of prime numbers 230 may further produce randomized hash codes 525, increasing the cryptographic strength of the hash module 505.

Once the hash logic 515 processes the set of prime numbers 230 and generates the hash code, the corresponding hash code 525 may also be stored in a hash table 520. The hash table 520 may be a data structure that can organize and store the one or more hash codes 525 to quickly retrieve them for a later use. In the hash table 520, each input prime number is mapped to its corresponding hash code. For instance, when a new prime number in the set of prime numbers 230 is processed by the hash logic 515, the generated hash code may be inserted into the hash table 520. However, if the new prime number has been processed before, the hash table 520 may quickly retrieve its stored hash code using fast lookups and comparisons. The hash table 520 may also need to handle potential collision scenarios when two different inputs (e.g., prime numbers 230) can produce the same hash code 525. Due to the use of the set of prime numbers 230, the occurrence of collisions may be significantly reduced, but in such rare scenarios, the hash table 520 can implement techniques like chaining (e.g., storing multiple hash codes as a linked list beginning with their hashed location in the hash table 520) or open addressing (e.g., finding an alternative hash location in the hash table 520) to maintain the integrity of hash codes.

The hash table 520 may not only function as a storage medium but may also serve as the repository of final output (e.g., the hash codes 525). The hash table 520 may hold outputs for a later comparison, retrieval, or verification. The one or more hash codes 525 can be efficiently retrieved from the hash table 520 and this may provide cryptographic guarantees for providing data integrity.

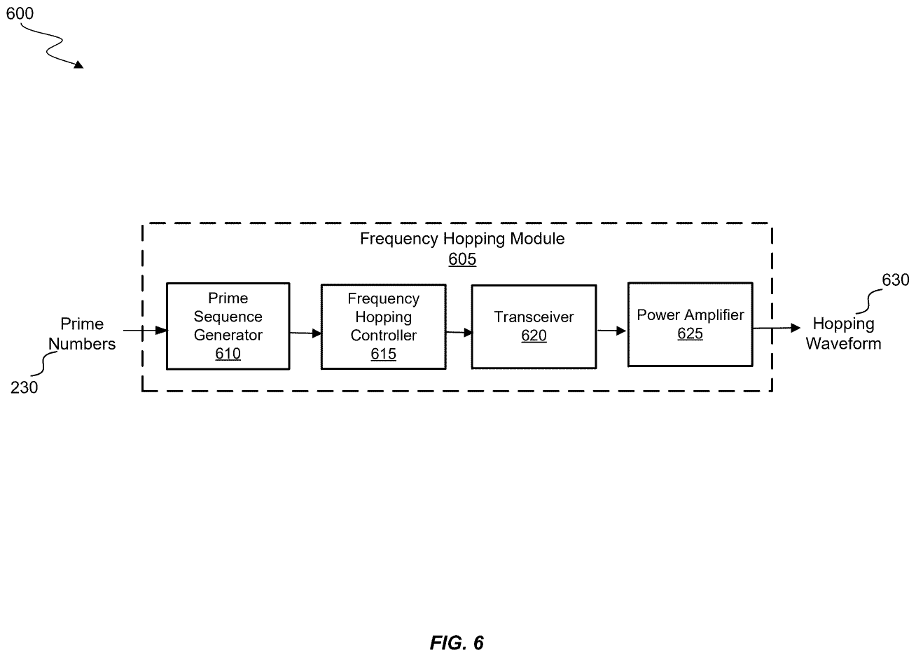

FIG. 6 shows an example implementation of a frequency hopping module that uses the set of prime numbers 230 to generate a hopping waveform. The process may begin with an input of the set of prime numbers 230 to a prime sequence generator 610 that is responsible for generating a specific order of frequencies for the frequency-hopping process. By using the set of prime numbers 230, the prime sequence generator 610 may ensure that the frequency hopping sequence can be both unique and difficult to predict, making the frequency hopping sequence resistant to interception or interference. The frequency hopping sequence produced by the generator provides a core pattern that will be followed by a frequency-hopping system, synchronizing the transmitter and receiver to operate on the same sequence of frequencies.

Once the sequence is generated, it may be passed to a frequency hopping controller 615. The frequency hopping controller 615 may receive the sequence and control the timing and duration of each frequency hop. Acting as the “brain” of the frequency-hopping process, the frequency hopping controller 615 may rapidly shift the operating frequency at regular intervals according to the generated sequence. By coordinating the timings of frequency changes, the frequency hopping controller 615 may provide a seamless frequency hopping process, maintaining the rhythm and security of the transmitted signal.

After the hopping controller has determined the set of hopping frequencies and their times, the signal may be modulated and transmitted through a transceiver 620. The transceiver 620 may modulate the signal onto the hopping frequencies, encoding the information within each frequency burst. Additionally, at the receiving end, the transceiver 620 may capture the signal, decoding it by matching with the hopping pattern that is generated by the prime number sequence generator 610.

The modulated signal then moves to a power amplifier 625 that boosts the signal strength, increasing its power before its transmission from an antenna, so that it can travel over longer distances and cater for signal attenuation during its propagation in the environment. Amplification of the signal helps in maintaining a hopping signal even in environments that may have a significant interference from other signals.

Finally, the amplified signal may reach the antenna of a sending device, which outputs a hopping waveform 630. Here, the antenna may broadcast the frequency-hopped signal, which may now follow the unique, prime-sequence-generated hopping pattern across the airwaves. As a result, the hopping waveform 630—a signal that may switch frequencies in rapid bursts—creates a resilient communication channel that is not only secure and but also resists interference. The hopping waveform 630 may be challenging to intercept or jam, as the frequency pattern is governed by the prime sequence, providing a secure transmission that may be used for sensitive or secure data applications.

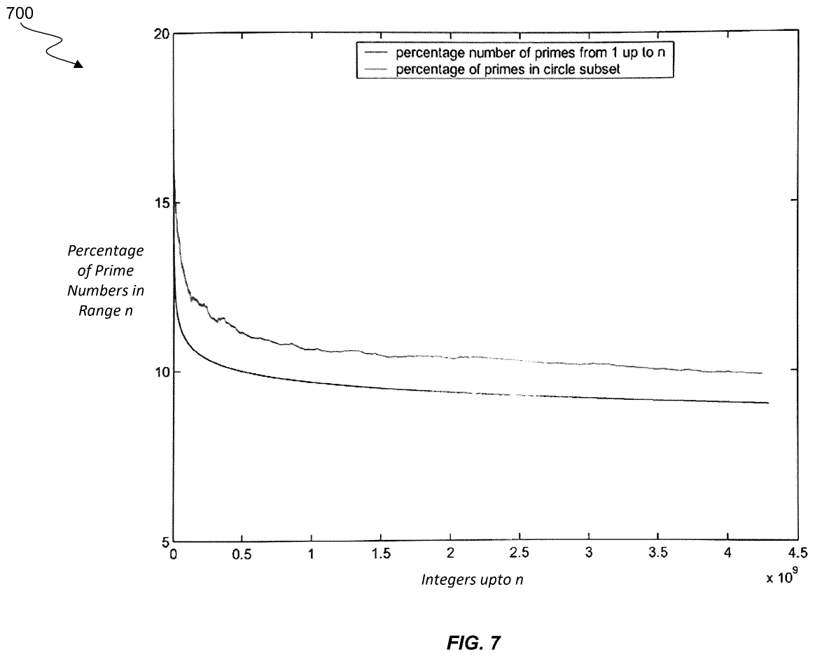

FIG. 7 illustrates an example plot 700 of the estimated percentage distribution of the elements of the set of prime numbers 230 within an increasing sequential range of integers, in comparison with a subset of prime numbers that are located inside the geometric shape 315. The x-axis of the plot 700 may represent a sequential range of integers from 0 to approximately 4.5×10⁹, capturing an upper bound n. The y-axis may denote the percentage of numbers in this range that are prime numbers.

The plot 700 displays two distinct lines: one reflecting the overall density of primes in the set of prime numbers 230 from 1 to n (dark line), which decays exponentially initially and then somewhat stabilizes as the value of n increases and this is consistent with prime number distribution patterns disclosed in the prior art. The other line (red line) shows the density of primes in the set of prime numbers 230, generated using the geometric shape 315 (e.g., a circle or a sphere). The elements in the set of prime numbers 230 consistently show a higher density, implying a more concentrated distribution of primes enclosed within geometrically defined regions compared to searching in a random space.

This can imply that for specific subsets (e.g., geometrically constrained regions like circles), the density of the prime numbers may be higher compared to when searing in a random range. This insight can have implications for prime number generation algorithms, as understanding the spatial density of set of prime numbers 230 may lead to secure yet efficient methods for generating cryptographic keys.

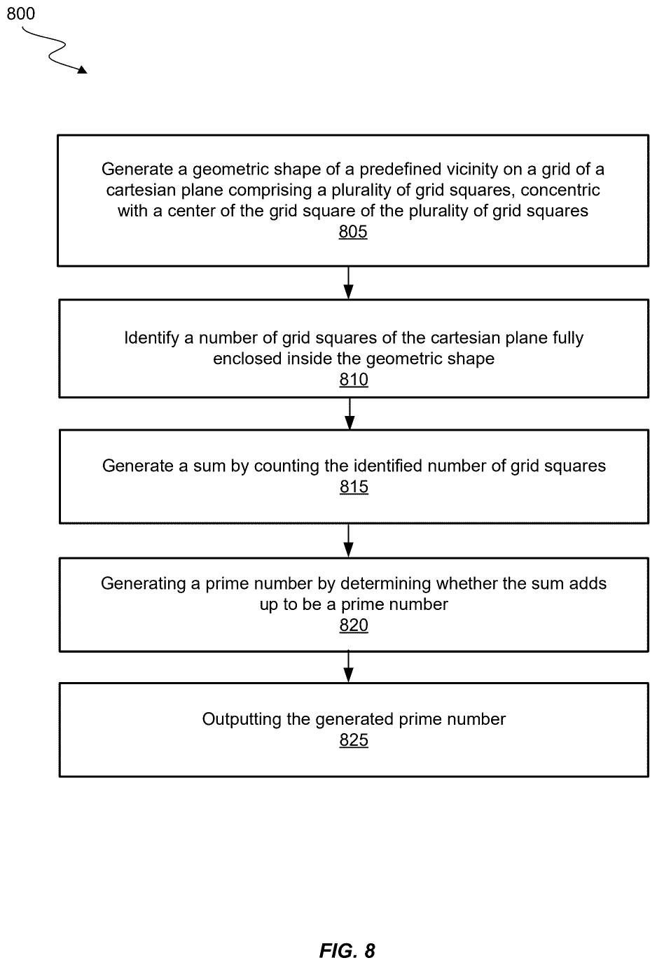

FIG. 8 shows an example flowchart for searching of the prime numbers 230 in a vicinity in accordance with some embodiments of the present disclosure. At block 805, the geometric shape of a predefined vicinity (A) may be generated on the grid of the cartesian plane. The vicinity A may refer to an area of the geometric shape, for example, in the context of the geometric shape being a circle, the vicinity A may refer to the area of the circle, computed as:

$$A = π {r}^{2} , \qquad ( Eq 3 )$$

where r is the radius of the circle. The vicinity A may be determined using the Eq 3, where r is the radius of the geometric shape. By defining a predefined vicinity A, the system may compute r and adjust the search area for prime search. The radius r may be iteratively increased and/or decreased (e.g., by small increments like 0.5 or 1 unit) to expand and/or reduce the region enclosed by the geometric shape. Each increment creates a larger and/or smaller enclosed sphere in the infinite grid, which enlarges the search area for primes numbers. For geometric shapes other than the circle, the vicinity may represent a volume or space determined by the geometric shape's boundaries, for example, for a sphere:

$$V = \frac{4}{3} π {r}^{3} , \qquad ( Eq 4 )$$

where r is a radius of the sphere

The geometric shape may be positioned on the grid to be concentric with any one of the grid squares of the plurality of grid squares of the grid. Once designed, the grid squares that may be fully enclosed inside the boundary of the geometric shape may be identified at block 810 by leveraging one or more pattern recognition models. The one or more pattern recognition models may be configured to distinguish the grid squares based on spatial relationships with the generated geometric shape 315, wherein the spatial relationships may include proximity and containment.

At block 815, a sum may be generated by counting the total number of identified grid squares enclosed inside the geometric shape. The prime number may be generated by determining whether the sum adds up to be a prime number, at block 820. The determination of prime numbers 230 may be done by using deterministic primality tests and/or classification models. The generated prime numbers 230 may be output, at block 825. The searching of a plurality of prime numbers 230 may be done by iteratively increasing and/or decreasing parameters of the geometric shape to expand the vicinity A. The parameters may refer to the radius, the height or the weight of the geometric shape. Thus, the vicinity A can be iteratively expanded and/or reduced to explore increasingly larger and/or smaller regions of the infinite grid, enabling a systematic search for prime numbers 230 within specified geometric constraints. This introduces a predefined search space (e.g., circle area) into the infinite grid that may give a measurable boundary that may dynamically expand and/or contract to discover one or more than one prime numbers 230. Verified prime numbers may be added to the set of prime numbers.

The identified prime numbers 230 may be by used in cryptosystems to encrypt or decrypt digital information, including but not limited to Time-based One-Time Password (TOTP). For the encryption and decryption, the encryption key comprising of one or more public and private keys may be generated. Additionally, prime numbers 230 may also be utilized in secure communication methods such as frequency hopping and hashing. In hashing, an input may be received, comprising of a set of tokens, unique within the input. The hash table may be generated by using the set of prime numbers 230 associated with each token of the set of tokens. Moreover, in frequency hopping, an input signal comprising a range of frequencies, may be adjusted in terms of the frequencies by mapping them to a sequence of frequencies. The sequence of frequencies may be generated based on a set of selected prime numbers from the set of prime numbers 230. In the case of multiple iterations of prime number generation, the verified prime number may be added as an element to the set of prime numbers 230.

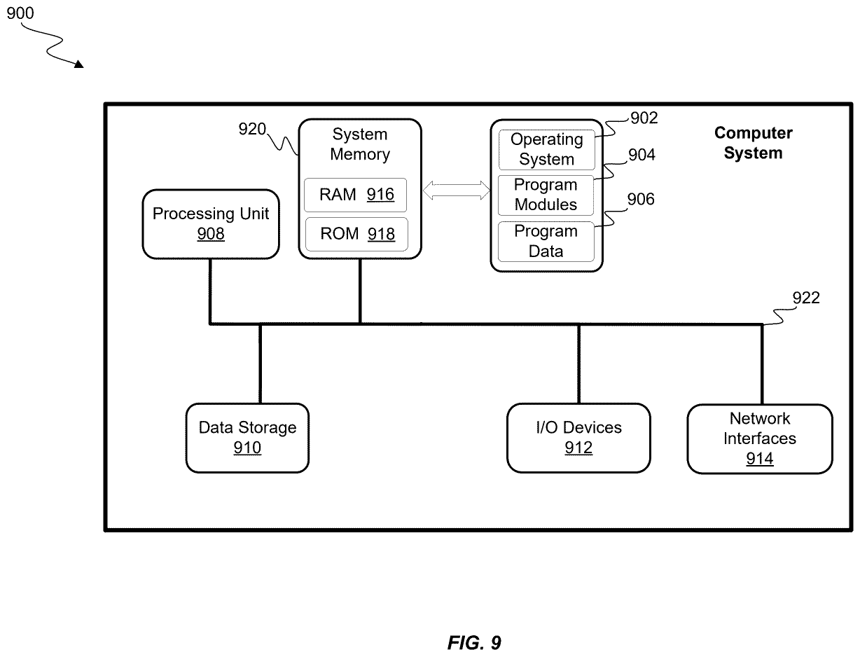

FIG. 9 shows an example illustration of the computing system 900 in which various embodiments of the present disclosure may be implemented. The computing system 900 can be used as the sender device 105 and the receiver device 135 as explained in FIG. 1. For example, the techniques as disclosed above in the present disclosure for encrypting digital information by utilizing a grid-based method for prime number generation, can be implemented in computer-executable instructions (e.g., organized in program modules 904). The program modules 904 can include the routines, programs, objects, components, and data structures that perform the tasks and implement the data types for implementing the techniques described above. The functionality described herein can be performed, at least in part, by one or more hardware logic components.

To provide additional context for various aspects thereof, FIG. 900 and the following description are intended to provide a brief, general description of the computing system 900 in which the various aspects can be implemented. While the description above is in the general context of computer-executable instructions that can run on one or more computers, those skilled in the art will recognize that a novel implementation also can be realized in combination with other program modules and/or as a combination of hardware and software. Computing system 900 or computer system for implementing various aspects includes a processing unit 908 having one or more processors (also referred to as microprocessors), a computer-readable storage medium (where the medium is any physical device or material on which data can be electronically and/or optically stored and retrieved) such as a data storage 910 unit (computer-readable storage medium/media also include magnetic disks, optical disks, solid state drives, external memory systems, and flash memory drives), and a system bus 912. The system bus 912 may provide an interface for system components including, but not limited to, system memory 914, to the processing unit 908. Such a system bus 912 can be of any of several types of bus structure that can further interconnect to memory bus (with or without controller), and a peripheral bus (e.g., Peripheral Component Interconnect (PCI), Peripheral Component Interconnect Express (PCIe), Accelerated Graphics Port (AGP), Low Pin Count (LPC), etc.), using any of a variety of commercially available bus architectures.

FIG. 9 shows an example configuration of a typical computer that may be other commercially available microprocessors such as single-processor, multi-processor, single-core units, and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be cooperatively coupled to one or more associated devices.

In some aspects, the computing system 900 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service and APIs (application program interlaces) as a service, for example. In some instances, the system memory 914 can include computer-readable storage (physical storage) medium such as a volatile memory (e.g., random-access memory (RAM) 916) and a non-volatile memory (e.g., read only memory (ROM) 918). A basic Input/output system (BIOS) can be stored in the non-volatile memory and includes the basic routines that facilitate the communication of data and signals between components within the computing system 900, such as during startup. The volatile memory also includes a high-speed RAM such as static RAM for caching data.

By way of example, and not limitation, the system memory 914 also may also include program modules 904, which may include client applications, Web browsers, mid-tier applications, relational database management systems (RDBMS), etc., program data 906, and an operating system 902. By way of example, operating system 902 may include various versions of Microsoft Windows®, Apple Macintosh®, and/or Linux operating systems, a variety of commercially-available UNIX® or UNIX-like operating systems (OS) (including without limitation the variety of Gnu's Not Unix (GNU)/Linux operating systems, the Google Chrome OS, and the like) and/or mobile operating systems such as iOS, Windows® Phone, Android OS, BlackBerry® OS, and Palm® OS operating systems. All or portions of operating system 902, program modules 904, and/or program data 906 can also be cached in memory such as the volatile memory and/or non-volatile memory, for example (RAM 916 or ROM 918). It is appreciated that the disclosed architecture can be implemented with various commercially available operating systems or combinations of operating systems (e.g., virtual machines).

In some other examples, the computing system 900 may have additional features or functionality. For example, the computing system 900 may also include additional data storage devices (removable and/or non-removable) such as, for example, magnetic disks, optical disks, or tape. Computer-readable media may include, at least, two types of computer-readable media, namely computer storage media and communication media. Computer storage media may include volatile and non-volatile, removable, and non-removable media implemented in any method or technology for storage of information, such as computer-readable instructions, data structures, program modules, or other data.

The system memory 914, and the data storage 910 including removable storage, and non-removable storage are all examples of computer storage media. Apart from RAM 916 and ROM 918, computer storage media includes, but is not limited to, electrically erasable programmable ROM (EEPROM), flash memory or other memory technology, compact disc (CD)-ROM, digital versatile disks (DVD), or other optical storage, magnetic cassettes, magnetic tape, magnetic disk storage or other magnetic storage devices, or any other non-transmission medium that can be used to store the targeted information and which can be accessed by the computing system 900. Moreover, the computer-readable media may include computer-executable instructions that, when executed by the processing unit 908, perform various functions and/or operations described herein. The communication media may embody computer-readable instructions, data structures, program modules, or other data in a modulated data signal, such as a carrier wave, or other transmission mechanism.

The computing system 900 may also include one or more input devices 920 such as keyboard, mouse, pen, voice input device, touch input device, etc. One or more output devices 922 such as a display, speakers, printers, etc. may also be included. These devices are well known in the art and are not discussed at length here. The computing system 900 may also include one or more network interfaces 924 to establish communication that may allow computing system 900 to communicate with other system or devices, such as over a network. These networks may include wired networks as well as wireless networks. Here, the computing system 900 is one example of a suitable device or system and is not intended to suggest any limitation as to the scope of use or functionality of the various embodiments described.

Other well-known computer systems, environments and/or configurations that may be suitable for use with the embodiments include, but are not limited to personal computers, server computers, hand-held or laptop devices, multiprocessor systems, microprocessor-based systems, set top boxes, game con soles, programmable consumer electronics, network PCs, minicomputers, mainframe computers, distributed computing environments that include any of the above systems or devices, and/or the like. For example, some or all of the components of computing system 900 may be implemented in a cloud computing environment, such that resources and/or services are made available via a computer network for selective use by the user devices.

Some embodiments of the present disclosure include a system including one or more data processors. In some embodiments, the system includes a non-transitory computer-readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
searching a prime number by:
generating a geometric shape of a predefined vicinity on a grid of a cartesian plane comprising a plurality of grid squares, concentric with a center of a grid square of the plurality of grid squares, wherein the vicinity corresponds to an area enclosed by the geometric shape;
identifying a number of grid squares of the cartesian plane fully enclosed inside the geometric shape; and
generating a sum by counting the identified number of grid squares;
generating a prime number by determining whether the sum adds up to be a prime number, wherein the determination is based on a deterministic primality test or a classification model; and
outputting the generated prime number.

2. The computer-implemented method of claim 1, wherein the geometric shape comprises a circle, a rectangle, an ellipse, or a square, or a combination thereof.

3. The computer-implemented method of claim 1, further including:
iteratively increasing a parameter of the geometric shape to expand the vicinity; and
repeating the searching of prime numbers.

4. The computer-implemented method of claim 1, further including:
iteratively decreasing a parameter of the geometric shape to expand the vicinity; and
repeating the searching of prime numbers.

5. The computer-implemented method of claim 1, further including:
generating one or more prime numbers to generate an encryption key that is used to encrypt or decrypt digital information.

6. The computer-implemented method of claim 5, wherein the generated encryption key comprises of a public key and a private key associated with the one or more prime numbers.

7. The computer-implemented method of claim 1, further including:
receiving an input comprising a set of tokens that are unique within the input; and
generating a hash table by generating a set of prime numbers associated with each token of the set of tokens.

8. The computer-implemented method of claim 1, further including:
receiving an input signal;
selecting a sequence of frequencies by using prime numbers to design hopping patterns; and
adjusting frequencies of the input signal by mapping them to the selected sequence of frequencies.

9. The computer-implemented method of claim 1, wherein the identification of the number of grid squares of the cartesian plane fully enclosed inside the geometric shape is done by one or more pattern recognition models, wherein the one or more pattern recognition models are configured to distinguish grid squares based on spatial relationships with the generated geometric shape, wherein the spatial relationships include proximity and containment.

10. A computer-program product tangibly embodied in a non-transitory machine-readable storage medium, including instructions configured to cause one or more data processors to perform a set of actions including:
searching a prime number by:
generating a geometric shape of a predefined vicinity on a grid of a cartesian plane comprising a plurality of grid squares, concentric with a center of a grid square of the plurality of grid squares, wherein the vicinity corresponds to an area enclosed by the geometric shape;
identifying a number of grid squares of the cartesian plane fully enclosed inside the geometric shape; and
generating a sum by counting the identified number of grid squares;
generating a prime number by determining whether the sum adds up to be a prime number, wherein the determination is based on a deterministic primality test or a classification model;
outputting the generated prime number.

11. The computer-program product of claim 10, wherein the geometric shape comprises a circle, a rectangle, an ellipse, or a square, or a combination thereof.

12. The computer-program product of claim 10, wherein the et of actions further includes:
iteratively increasing a parameter of the geometric shape to expand the vicinity; and
repeating the searching of prime numbers.

13. The computer-program product of claim 10, wherein the et of actions further includes:
iteratively decreasing a parameter of the geometric shape to expand the vicinity; and
repeating the searching of prime numbers.

14. The computer-program product of claim 10, wherein the et of actions further includes:
generating one or more prime numbers to generate an encryption key that is used to encrypt or decrypt digital information.

15. The computer-program product of claim 14, wherein the generated encryption key comprises of a public key and a private key associated with the one or more prime numbers.

16. The computer-program product of claim 10, wherein the et of actions further includes:
receiving an input comprising a set of tokens that are unique within the input; and
generating a hash table by generating a set of prime numbers associated with each token of the set of tokens.

17. The computer-program product of claim 10, wherein the et of actions further includes:
receiving an input signal;
selecting a sequence of frequencies by using prime numbers to design hopping patterns; and
adjusting frequencies of the input signal by mapping them to the selected sequence of frequencies.

18. The computer-program product of claim 10, wherein the identification of the number of grid squares of the cartesian plane fully enclosed inside the geometric shape is done by one or more pattern recognition models, wherein the one or more pattern recognition models are configured to distinguish grid squares based on spatial relationships with the generated geometric shape, wherein the spatial relationships include proximity and containment.

19. A system comprising:
one or more processors;
one or more non-transitory computer-readable media storing instructions, which, when executed by the system, cause the system to perform part a set of actions including:
searching a prime number by:
generating a geometric shape of a predefined vicinity on a grid of a cartesian plane comprising a plurality of grid squares, concentric with a center of a grid square of the plurality of grid squares, wherein the vicinity corresponds to an area enclosed by the geometric shape;
identifying a number of grid squares of the cartesian plane fully enclosed inside the geometric shape; and
generating a sum by counting the identified number of grid squares;
generating a prime number by determining whether the sum adds up to be a prime number, wherein the determination is based on a deterministic primality test or a classification model; and
outputting the generated prime number.

20. The system of claim 19, wherein the geometric shape comprises a circle, a rectangle, an ellipse, or a square, or a combination thereof.
